(19) United States
(12) Patent Application Publication
(10) Pub. No.: US 2016/0349808 A1
(43) Pub. Date: Dec. 1, 2016

(54) Micro-Hole Perforated Structure

(71) Applicant: Microsoft Technology Licensing, LLC, Redmond, WA (US)

(72) Inventors: Gregory M. Daly, Seattle, WA (US); Karsten Aagaard, Monroe, WA (US); Brett A. Muzzey, Seattle, WA (US)

(21) Appl. No.: 14/725,330

(22) Filed: May 29, 2015

(51) Int. Cl. G06F 1/20; B29C 70/46; G06F 1/16; B29C 70/54

(52) U.S. Cl. CPC G06F 1/20; B29C 70/545; B29C 70/467; G06F 1/1656; B29K 2063/00

(57) ABSTRACT

Micro-hole structures are described herein that may be implemented for device ventilation, protection, and design. The micro-hole structures include multiple micro-holes that are imperceptible to users at ordinary viewing angles and distances, and are thus porous structures that appear to be solid. A micro-hole structure may be formed as a housing of a device or as a structure to be attached to the housing of the device. A device with a micro-hole structure housing enables thermal ventilation from heat-producing components located within the housing. Additionally, micro-holes of a micro-hole structure may be organized to operate as a design element for the device while simultaneously providing ventilation. The micro-holes are sufficiently small to allow for passage of air through the micro-hole structure while also prohibiting entrance of water and/or other contaminants into the housing of the device.

### SUMMARY

Micro-hole structures for device ventilation, protection, and design are described herein. In one or more implementations, a micro-hole structure is formed as including multiple micro-holes that are imperceptible to users at ordinary viewing angles and distances, and is thus a porous structure that appears to be solid. Techniques described herein enable a housing of a device to be formed as a micro-hole structure without the need for additional machining or finishing. A device with a micro-hole structure housing enables thermal ventilation from heat-producing components located within the housing. Additionally, micro-holes of a micro-hole structure may be organized to operate as a design element for the device while simultaneously providing ventilation. The micro-holes are sufficiently small to allow for passage of air through the micro-hole structure while also prohibiting entrance of water and/or other contaminants into the housing of the device.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 illustrates an environment in an example implementation that is operable to employ micro-hole structures in accordance with one or more implementations.

FIG. 2 illustrates an example implementation of a ventilation system of FIG. 1 that includes micro-hole structures.

FIG. 3 illustrates an example die press for forming a micro-hole structure in accordance with one or more implementations.

FIG. 4 illustrates an example procedure for forming a micro-hole structure in accordance with one or more implementations.

FIG. 5 illustrates an example implementation of a micro-hole structure formed as a housing of a computing device.

FIG. 6 illustrates an example implementation of a micro-hole structure that is attachable to a housing of a computing device.

FIG. 7 illustrates example perspective views of a housing of a computing device that includes micro-hole structures formed as a logo display in accordance with one or more implementations.

FIG. 8 illustrates an example pattern of micro-holes of a micro-hole structure in accordance with one or more implementations.

FIG. 9 illustrates an example system including various components of an example device that can be implemented as any type of computing device as described with reference to FIGS. 1-8 to implement the techniques described herein.

### DETAILED DESCRIPTION

### Overview

As computing devices continue to decrease in size, the available area for venting airflow through the device for thermal dissipation similarly decreases. This restriction on thermal dissipation frequently results in compromising maximum processing performance of the computing device, particularly in today's thin and light mobile computing devices. The thinness of some devices limits the amount of space available for heat transfer devices and ventilation system components in the devices. As a result, maximum performance of these computing devices is constrained by a form factor of the device. Conventional ventilation system designs employed large intake and exhaust vents. However, these large intake and exhaust vents are visible and aesthetically unpleasing, and further allow for contaminants to enter a housing of the computing device and damage interior computing device components. Furthermore, industrial design often mandates a computing device with as few holes as possible. Accordingly, balancing computing device design against thermal ventilation and protection of the device's interior components presents a considerable challenge, particularly as devices continue to decrease in size.

Micro-hole structures are described for device ventilation, protection, and design. In one or more implementations, a micro-hole structure is formed that includes a plurality of micro-holes that are imperceptible to users unaided at ordinary viewing angles and distances. The micro-hole structure are constructed by stretching a material over a die having a plurality of pins that define the location of a plurality of micro-holes and curing the material to form a rigid structure. The resulting micro-hole structure is a rigid, porous material that appears solid to users at ordinary viewing angles and distances. The micro-hole structure is usable in a variety of different scenarios, such as to form at least a portion of housing of a computing device, attached to a housing of a computing device, and so on. Inclusion of the micro-hole structure may be used to eliminate machined ventilation components into the housing after the housing has been formed.

Each micro-hole structure may include holes of a sufficient size to permit air flow and restrict contaminants, e.g., having diameters of about fifty to two hundred microns, and may be arranged in a variety of patterns or designs. Micro-hole of this size thus enable air to pass through the micro-hole structure while preventing unwanted contaminants such as dust and water from permeating the structure. Additionally, the micro-holes of a micro-hole structure may be arranged in a design that is illuminated by a light source disposed behind the micro-hole structure. Accordingly, the otherwise imperceptible micro-hole structures may be leveraged to operate as design elements in addition to device ventilation and protection components.

In the following discussion, an example environment is first described that may employ the micro-hole structures described herein. Example procedures are then described which may be performed in the example environment as well as other environments. Consequently, performance of the example procedures is not limited to the example environment and the example environment is not limited to performance of the example procedures.

Example Operating Environment

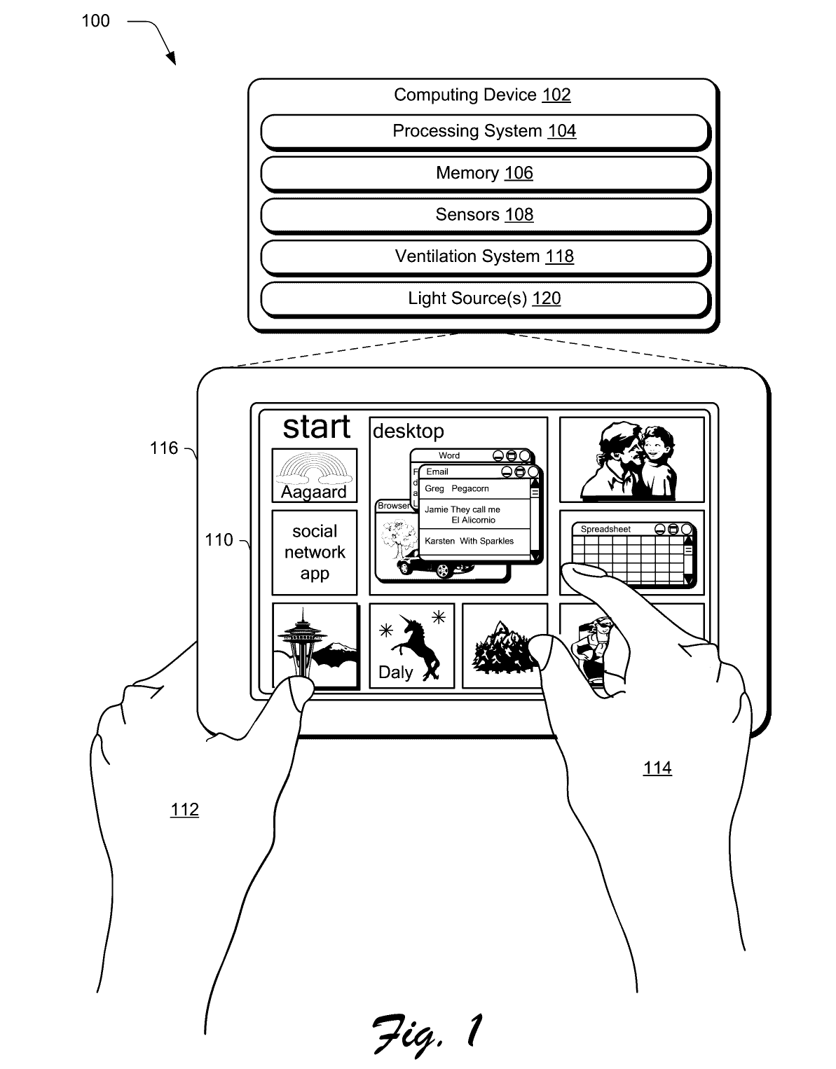

FIG. 1 illustrates an environment 100 in an example implementation that is operable to employ micro-hole structures described herein. The illustrated environment 100 includes a computing device 102 having a processing system 104 and a computer-readable storage medium that is illustrated as a memory 106, although other configurations are also contemplated as further described below.

The computing device 102 may be configured in a variety of ways. For example, a computing device may be configured as a computer that is capable of communicating over a network, such as a desktop computer, a mobile station, an entertainment appliance, a set-top box communicatively coupled to a display device, a wireless phone, a game console, and so forth. Thus, the computing device 102 may range from full resource devices with substantial memory and processor resources (e.g., personal computers, game consoles) to a low-resource device with limited memory and/or processing resources (e.g., traditional set-top boxes, hand-held game consoles). Additionally, although a single computing device 102 is shown, the computing device 102 may be representative of a plurality of different devices, such as multiple servers utilized by a business to perform operations such as by a web service, a remote control and set-top box combination, an image capture device and a game console configured to capture gestures, and so on. Further discussion of different configurations that may be assumed by the computing device may be found in relation to FIG. 10.

The computing device 102 may support a variety of different interactions. For example, the computing device 102 may include one or more hardware devices that a user may manipulate to interact with the device, such as a keyboard, cursor control device (e.g., a mouse, track pad, or touch device), and so on. The computing device 102 may also support gestures, which may be detected in a variety of ways. The computing device 102, for instance, may support touch gestures that are detected using touch functionality of the computing device 102. The sensors 108, for instance, may be configured to provide touchscreen functionality in conjunction with the display device 110, alone as part of a track pad, and so on. An example of this is illustrated in FIG. 1 in which first and second hands 112, 114 of a user are illustrated. The first hand 112 of the user is shown as holding a housing 116 of the computing device 102. The second hand 114 of the user is illustrated as providing one or more inputs that are detected using touchscreen functionality of the display device 110 to perform an operation.

In accordance with principles discussed in this document, the computing device 102 includes a ventilation system 118 used for thermal management that may include one or more micro-hole structures. As discussed in the details section that follows, the micro-hole structures may be formed as one or more very small micro-holes that are invisible to unaided human eyes. In other words, the micro-holes may be configured to be imperceptible to users unaided at ordinary viewing distances and angles. Additionally, the micro-holes may be illuminated by one or more light sources 120 disposed within the computing device, allowing light emitted from the light sources to pass through the micro-holes to the outside of the computing device 102. Because the micro-holes are configured to be imperceptible to users at ordinary viewing distances and angles, illuminating the micro-holes may cause a user to perceive that the housing 116 is glowing at portions of the housing 116 supporting micro-holes. A large number of micro-holes may be employed for each micro-hole structure to enable sufficient air flow for cooling.

Micro-Hole Structure Construction and Implementation

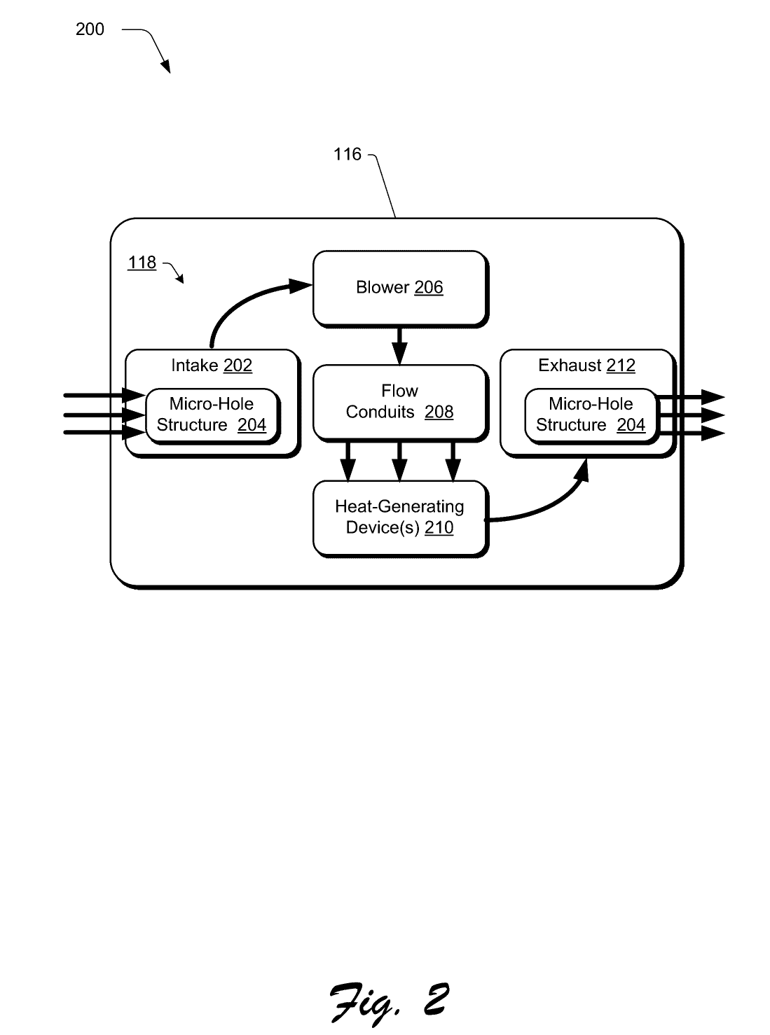

FIG. 2 depicts generally at 200 an example representation of a ventilation system 118 of FIG. 1 that employs micro-hole structures in accordance with one or more implementations. FIG. 2 additionally represents flow through the ventilation system 118 for cooling of components of a corresponding computing device using arrows to show the general flow path from component to component. Although aspects are described herein in relation to air cooling, comparable techniques may be used in connection with other types of fluid cooling systems that employ different types of gases and even liquids.

In the example of FIG. 2, the ventilation system 118 is illustrated as being arranged within the housing 120 of the computing device 102 of FIG. 1. The ventilation system 118 includes an intake 202 that is associated with one or more micro-hole structures 204. A blower 206 is provided that is designed to pull air from an exterior of the housing 116 through the micro-hole structures 204 into an interior of the housing. The blower 206 is representative of functionality to move and disperse cooling air for the system. The blower 206 may be configured in various ways, such as being an axial fan or a centrifugal blower for moving air. Pumps, impellers, and other types of fluid movers may also be employed in alternative designs and/or in conjunction with other types of cooling fluids.

As represented, the blower 206 is designed to disperse air throughout the interior of the housing via one or more flow conduits 208 to various heat-generating devices 210. Various types of flow conduits 208 are contemplated such as channels that are formed in the housing, piping systems, tubes, manifolds, baffles, and so forth. The heat-generating devices 210 may include a processing system 104 as described in relation to FIG. 1 as well as other components of the computing device such as a power supply unit, a battery, a microprocessor, and a graphics processor, to name a few examples.

Cooling air that is drawn into the device by the blower 206 and delivered to the heat-generating devices 210 operates to cool the device by thermal conductivity, which heats up the air. The heated air flows from the heat-generating devices 210 to exhaust 212 components of the ventilation system. The exhaust 212 may be associated with one or more micro-hole structures 204. Although illustrated separately, it should be understood that intake 202 and exhaust 212 may both utilize a same, single micro-hole structure 204 to ventilate the device. For example, a substantially large micro-hole structure may use one or more regions of the structure for the intake 202 and one or more different regions of the structure for the exhaust 212.

Micro-hole structures 204 represent structures that enable air (or other fluids) to be passed between separate areas, such as between an exterior and interior of a housing 116. Generally, the micro-hole structures 204 are designed to allow sufficient flow for a particular application and such that the micro-holes are invisible or barely visible to users, e.g., unaided human viewers. In order to remain invisible or barely visible to users, individual ones of a plurality of micro-holes of a micro-hole structure may be configured to be less than approximately two hundred and fifty microns wide in at least one dimension. Micro-holes of such small sizes may be substantially invisible to unaided human eyes. Given the small size of individual micro-holes of a micro-hole structure, the number of micro-holes in a micro-hole structure may be substantially large to allow for sufficient flow through the ventilation system. It should be noted that the number of micro-holes in a micro-hole structure will vary based on an intended implementation for the micro-hole structure.

As is discussed in further detail below, micro-hole structures may be formed directly as part of the housing 116 or as a separate micro-hole structure that is attachable to the housing 116. In implementations where the micro-hole structure is configured as a separate structure that is attachable to the housing, the micro-hole structure may be configured to match the visual appearance of the surrounding part of the housing to which the structure is to be attached. For example, micro-hole structures may be configured to match characteristics such as the texture, color, material, and/or patterning of the surface of a housing.

The micro-holes of the micro-hole structure may be tightly packed together at portions of the housing 116 designated for micro-hole structures 204. For instance, the portions of the housing 116 having micro-hole structures 204 may include “open areas,” formed by the micro-holes, covering greater than fifty percent of an entire area of the micro-hole structure. The micro-holes may be arranged in a pattern such as a hexagonal (e.g., honey-comb) or other polygonal pattern, a checkerboard pattern, in offset rows and/or columns, or a spiral pattern, to name a few examples. In implementation, the micro-holes may have diameters that are within a range of about fifty microns to two-hundred microns. The size may be selected to ensure proper air flow as well as concealment of the micro-hole structures and different sizes may be employed for different applications.

Further, the micro-holes having diameters within a range of about fifty microns to two-hundred microns may be sufficient to allow air flow through a micro-hole structure while simultaneously filtering out contaminants, liquids, and other harmful substances that may otherwise damage sensitive components disposed within the housing 116. Additionally, a single micro-hole structure may include multiple different sizes and arrangements of micro-holes. In one or more implementations, a density of the micro-holes for areas of the housing having micro-hole structures is in a range of about twelve-thousand to fifty thousand holes per square inch. It should be noted that the density of micro-holes for a micro-hole structure will vary depending on the application and/or designed flow level.

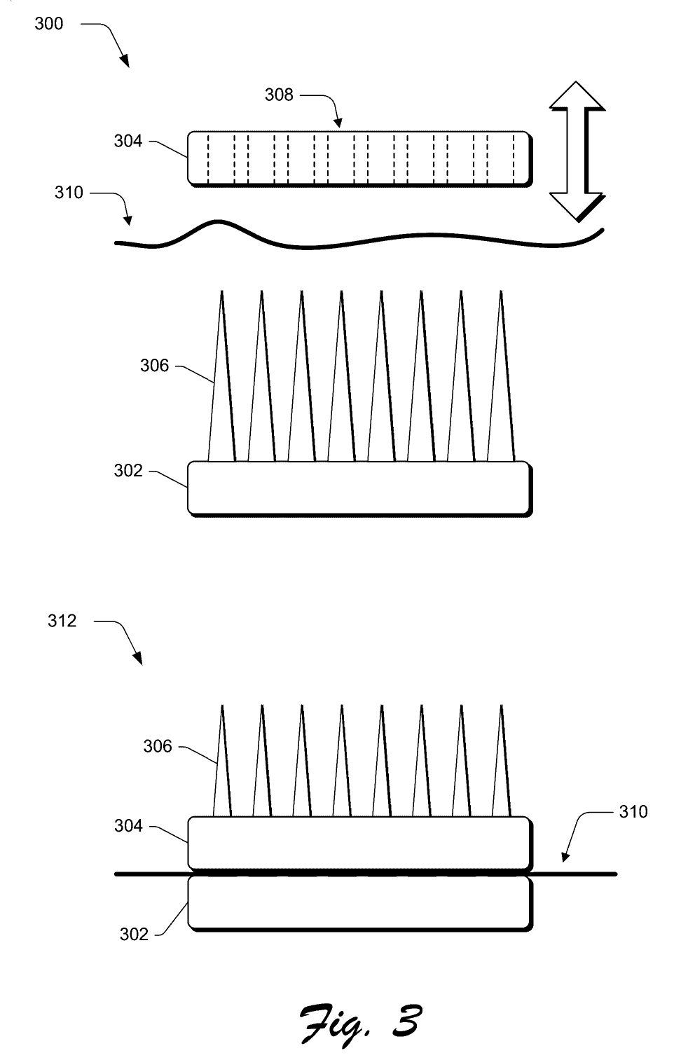

In one or more implementations, the micro-holes are formed generally as circular tubes that extend through a wall of the housing 116 or through a wall of the separate micro-hole structure that is attachable to the housing. The micro-holes may behave like tiny pipes from a fluid flow perspective. Although circular tubes may be employed, other micro-hole profiles such as conical shaped tubes, elliptical pipes, hexagonal shaped structures, and even rectangular passages may be formed depending upon the particular application and formation techniques utilized. The micro-hole structures may be formed as discussed with respect to FIG. 3.

FIG. 3 illustrates at 300 and 312 a side view of an example die press used to form a micro-hole structure in accordance with one or more implementations. Here, the die press includes a base die 302 and a top die 304 configured to form a micro-hole structure to be used with one or more implementations described herein. Specifically, the base die 302 includes a plurality of pins 306 arranged to define corresponding locations of a plurality of micro-holes of the micro-hole structure.

As illustrated, the plurality of pins 306 are configured as cones with tips that extend away from the base die 302 and are configured to puncture a material 310 to be used in forming the micro-hole structure. The material 310 may be carbon fiber, or other materials such as a structural cloth or malleable metal alloy, to name a few examples. The pins 306 are not limited to the illustrated conical profile and may be configured in any geometry suitable to form the micro-hole profiles described above.

The plurality of pins 306 taper out from the tips of the cones to bases that are disposed on the base die 302. The bases of the plurality of pins 306 define a corresponding profile of a micro-hole to be formed, as is described in further detail below. For example, a pin 306 having a base diameter of approximately two hundred and fifty microns defines a micro-hole having a width of approximately two hundred and fifty microns.

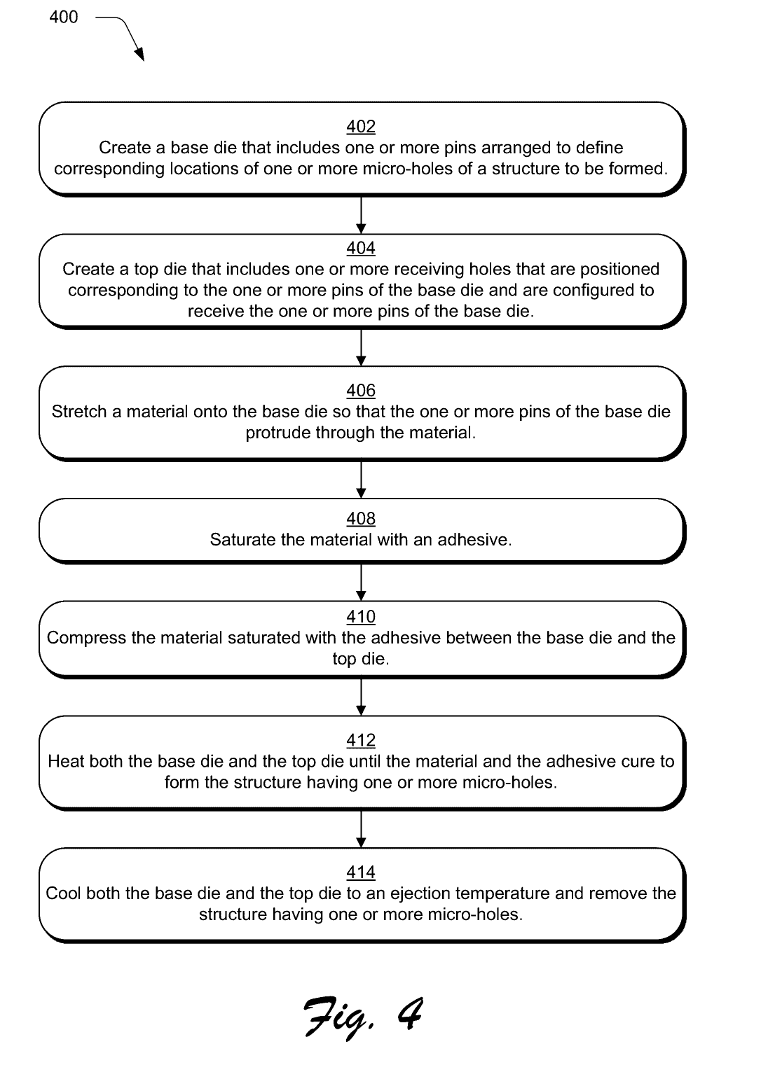

The top die 304 includes a plurality of receiving holes 308, illustrated in phantom, that are configured to receive the plurality of pins 306 when the top die is pressed against the base die 302. As illustrated, the plurality of receiving holes 308 are configured as cylinders that allow the plurality of pins 306 to pass through the top die 304 when the top die is pressed against the base die 302. Alternatively, the plurality of receiving holes 308 of the top die 304 may be configured as cavities to receive the plurality of pins 306, such that the plurality of pins are contained within the cavities and do not pass through the top die when the top and base dies are pressed together. FIG. 3 at 312 illustrates an example configuration of the material 310 pressed between the base die 302 and the top die 304, with the receiving holes 308 of the top die configured as cylinders allowing the pins 306 to pass through the top die. As is described in further detail below with respect to FIG. 4, the die press illustrated in FIG. 3 may be used to form the micro-hole structures discussed herein.

FIG. 4 illustrates an example procedure 400 for forming a micro-hole structure in accordance with one or more implementations. The following discussion describes techniques that may be used to produce and assemble components of a computing device that include micro-hole structures for ventilation as described in this document. The procedure is shown as a set of blocks that specify operations performed by one or more devices and are not necessarily limited to the orders shown for performing the operations by the respective blocks. In portions of the following discussion, reference may be made to the operating environment 100 of FIG. 1 and the example details of FIGS. 2 and 3, respectively.

A base die is created that includes one or more pins arranged to define corresponding locations of one or more micro-holes of a micro-hole structure to be formed (block 402). For example, base die 302 may be configured to include a plurality of pins 306 arranged to define micro-hole locations for a micro-hole structure 204 of housing 116. As discussed, the micro-hole structure may be formed directly as part of the housing 116 or as a separate micro-hole structure that is attachable to the housing 116.

In some examples, the micro-hole structure forms an entirety of the housing 116. In these examples, the base die 302 is created to define a form factor of the housing 116 of a computing device, for example computing device 102 of FIG. 1. In other implementations, the base die 302 is created to define a micro-structure to be attached to the housing 116. The plurality of pins 306 may be arranged in any configuration to define corresponding micro-hole locations of the micro-hole structure 204.

A top die is created that includes one or more receiving holes that are positioned corresponding to the one or more pins of the base die and are configured to receive the one or more pins of the base die when the top die and base die are positioned proximal to one another and pressed together (block 404). For example, top die 304 may be configured to include a plurality of receiving holes 308 that are configured to receive the plurality of pins 306 of base die 302 when the base die and the top die are pressed together, as illustrated in FIG. 3 at 312.

Returning to FIG. 4, a material is stretched onto the base die so that the one or more pins of the base die protrude through the material (block 406). For example, material 310 may be stretched across the one or more pins 306 of the base die 302. In the illustrated example, the material 310 is punctured by tips of the conically shaped pins 306 and pulled down to the base of the pins disposed on the base die. As discussed, the geometry of the pins 306 will define a profile of one or more micro-holes to be formed in the material 310. For example, micro-holes formed in the material 310 as illustrated at 312 will have resulting conical profiles defined by a cross section of the plurality of pins 306 that intersects the material.

The material is then saturated with an adhesive (block 408). For example, in an embodiment where the material 310 is carbon fiber, adhesive is applied to the carbon fiber until the carbon fiber is saturated with the adhesive. The adhesive may be epoxy or any other heat curable adhesive such as silicon, polyurethane, or polysulfide, to name a few examples.

The saturated material is then compressed between the base die and the top die (block 410). For example, after the material 310 has been stretched across the one or more pins 306 of the base die 302 and saturated with an adhesive, the top die 304 may be compressed onto the base die as illustrated in FIG. 3 at 312. As illustrated at 312, the material 310 is compressed between base die 302 and top die 304 so that the material conforms to a form factor defined by the opposing surfaces of the top die and the base die that contact the material when pressed together. For example, if the top die and the base die are configured to define a form factor of the housing 116 of a computing device, the compressed material would adhere to the form factor of the housing 116 of the computing device. Alternatively, the top die and the base die may be configured to define a micro-hole structure to be attached to a housing 116 of a computing device.

Both the base die and the top die are then heated until the material saturated with the adhesive cures to form a structure having one or more micro-holes (block 412). It should be understood that a temperature to which the top die and the base die are heated will vary dependent on the material and the adhesive selected to create the micro-hole structure.

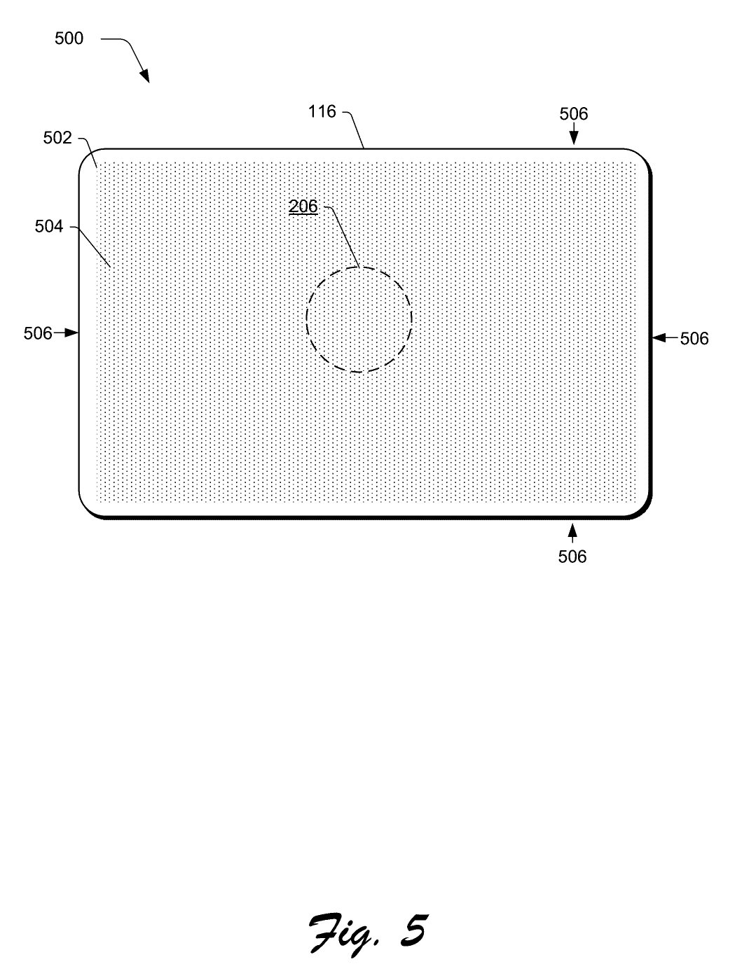

Finally, both the base die and the top die are cooled to a removal temperature and the micro-hole structure is removed from the die press (block 414). Example implementations of micro-hole structures formed through procedure 400 are discussed in further detail below with respect to FIGS. 5-8.

FIG. 5 depicts generally at 500 an example implementation of a micro-hole structure formed as a housing of a computing device. Here, a back surface 502 of a housing 116 is illustrated as having an area including micro-holes 504 configured in accordance with one or more implementations. The back surface 502 may be considered a surface that is opposite of a front surface configured to contain a display device 110, such as the surface shown for the example computing device 102 of FIG. 1.

In the depicted example of FIG. 5, the area including micro-holes 504 is generally centrally located both horizontally and vertically with respect to the back surface 502, although other locations on the back surface, along various edges 506, and/or on a front surface (not shown) are also contemplated. Additionally, while a generally rectangular area including micro-holes is shown, areas having other regular shapes (elliptical, circular, hexagonal, etc.) and irregular shapes may also be employed.

The area including micro-holes 504 is depicted as being aligned with a blower 206 within the housing 116. In this configuration, the area including micro-holes of the housing 116 is positioned directly above and/or in-line with an intake or an exhaust for the blower 206 to optimize flow. Alternatively, the back surface 502 may be configured so that the area 504 including micro-holes covers substantially the entire back surface 502 of the housing 116. Additionally, the various edges 506 and/or the front surface may be configured such that the area including micro-holes covers substantially the entirety of the housing 116.

Accordingly, a housing 116 that supports the micro-holes described herein may be “breathable,” such that it permits air flow between an interior of the housing and an exterior of the housing without use of the blower 206. Although FIG. 5 illustrates the housing 116 as including only one area including micro-holes 504, this illustration is not intended to be limiting, and the housing may contain any number of discrete areas including micro-holes 504. For example, in implementations where the computing device is configured without the blower 206, the back surface 502 may include one or more areas including micro-holes 504 positioned directly above and/or in-line with one or more heat-generating devices 210 disposed within the computing device. By positioning micro-holes directly above and/or in-line with a heat-generating device, heat may escape from an interior of the housing 116 to an exterior of the housing without the aid of a blower. In contrast to this micro-hole structure formed as a housing of the computing device, a micro-hole structure may be formed as a separate structure to be attached to the housing.

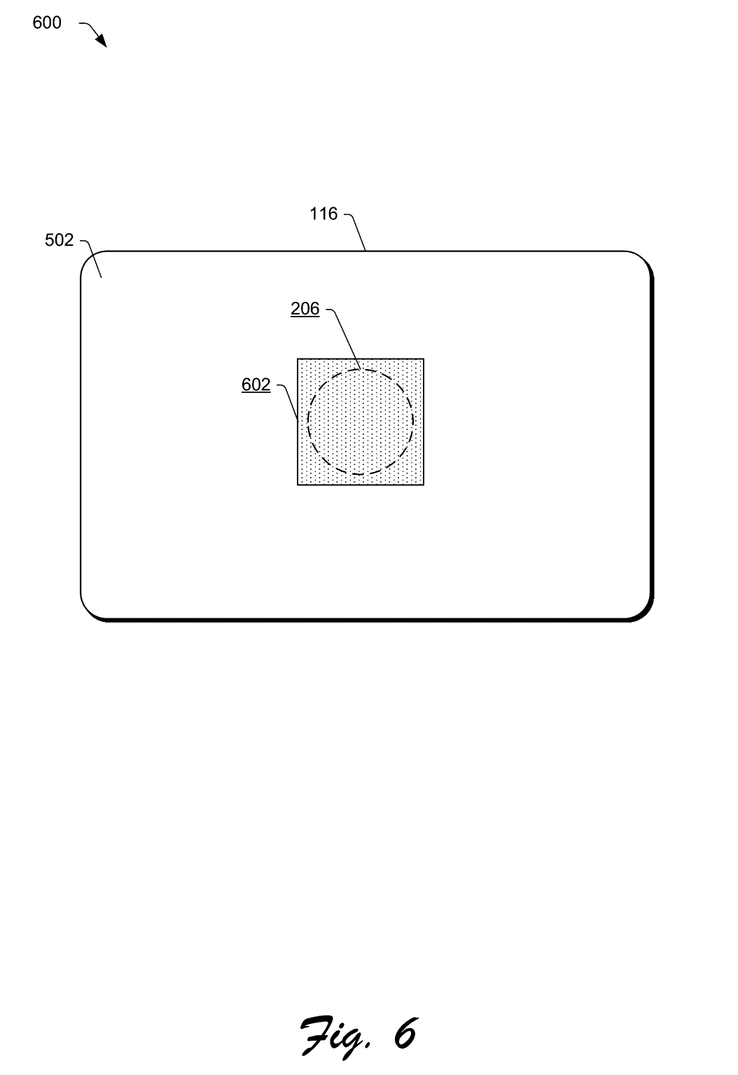

FIG. 6 illustrates generally at 600 an example implementation of a micro-hole structure that is attachable to a housing of a computing device. Here, a micro-hole structure 602 may be formed, through the techniques described above with respect to FIGS. 3 and 4, and subsequently attached to the back surface 502 of the housing 116. Forming the micro-hole structure 602 separately from the housing 116 enables the micro-hole structure to have different characteristics and material properties from the housing itself. For example, the housing and micro-hole structure may be made from different materials, have different thicknesses, have different thermal properties, and so forth.

The micro-hole structure 602 may be attached to the housing such that the micro-hole structure is aligned with the blower 206 and/or a position for mounting a blower within the housing 116. Additionally or alternatively, the micro-hole structure 602 may be attached to the housing such that the micro-hole structure is aligned with one or more heat-generating devices 210 disposed within the housing. Further, although FIG. 6 illustrates the housing 116 as including only one attachable micro-hole structure 602, this illustration is not intended to be limiting, and the housing may contain any number of attachable micro-hole structures 602.

The micro-hole structure 602 may be attached to the housing 116 in a variety of ways. For example, the housing 116 may include a passage, cutout, or receptacle into which the micro-hole structure 602 may be received. The micro-hole structure may then be secured in place using various techniques such as adhesive, fasteners, clips, welding, soldering, and so forth. Generally, the passage, cutout, or receptacle of the housing 116 is configured to match a footprint of the micro-hole structure 602, such as the rectangular shape depicted in the example of FIG. 6, or any other shape selected for a micro-hole structure 602. For example, micro-holes of one or more micro-structures may be configured in a shape of a corporate logo, as lettering for personalization of a device, and so on.

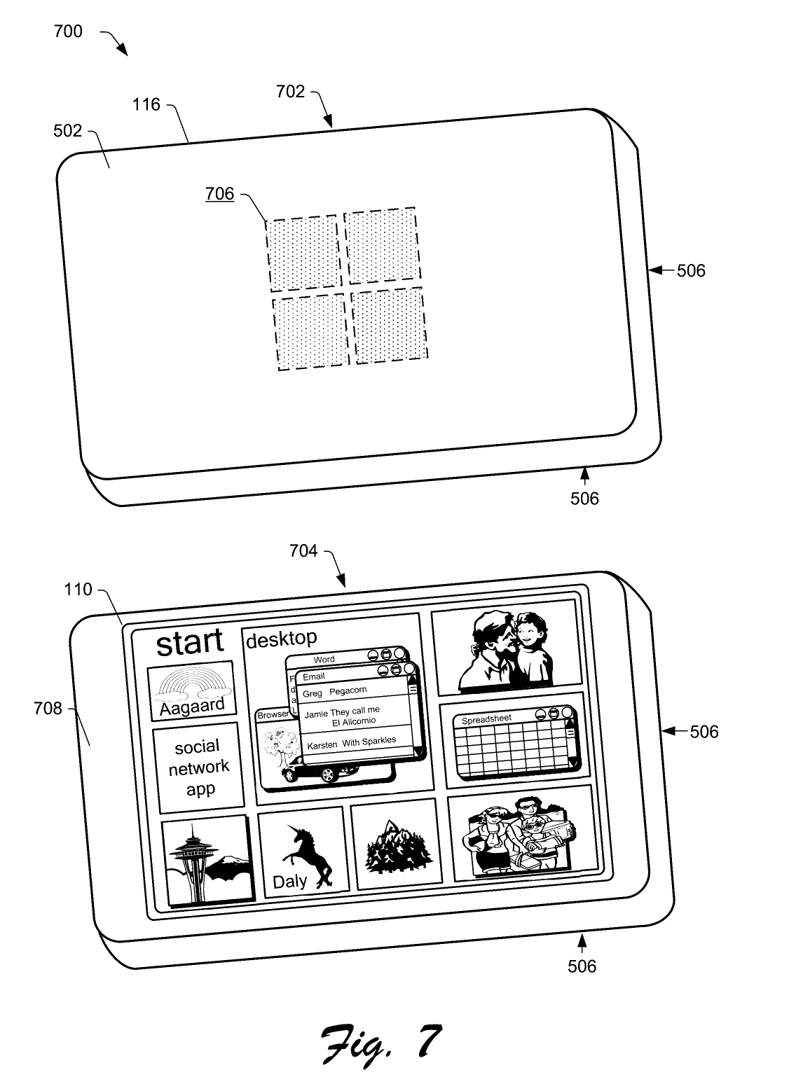

FIG. 7 depicts generally at 700 an example perspective view 702 of a back surface and an example perspective view 704 of a front surface of a computing device that illustrate example configurations of micro-holes of a micro-hole structure and example locations for micro-hole structures in accordance with one or more implementations. As illustrated, the back surface 502 is opposite a front surface 708 that together form a housing 116 of a computing device that includes a display device 110. The view 702 of the back surface 502 illustrates a micro-hole structure 706 formed as part of the back surface 502.

As illustrated, the micro-holes of micro-hole structure are configured in a shape of a corporate logo, such as a logo of the Microsoft® Corporation. The view 702 illustrates the positioning of the micro-hole structure 706 on the back surface 502 of the housing. In addition or alternatively, one or more micro-hole structures 204 may be associated with other locations on the back surface 502 and other surfaces of the device. For example, micro-hole structures may be positioned at any variety of locations on one or more of the edges 506 or on the front surface 708 of the housing 116. Thus, one or more micro-hole structures 204 may be provided with a device at various locations.

Additionally, although the micro-holes are generally sized such that they are imperceptible to users at ordinary viewing distances and angles, a light source such as the light source 120 disposed within the housing 116 as illustrated in FIG. 1 may be used to illuminate the micro-holes of one or more micro-hole structures. For example, returning to FIG. 7, a light source may be disposed within the housing 116 and positioned to emit light to pass through the micro-holes of the micro-hole structure 706. As illustrated, the micro-holes of micro-hole structure 706 are arranged in the shape of the Microsoft® Corporation logo. Accordingly, illuminating the micro-hole structure 706 may cause a user to perceive that the housing 116 features a glowing logo of the Microsoft® Corporation. As described herein, the light source 120 may be any suitable light source, such as a light-emitting diode, an incandescent lamp, or a laser, to name a few examples. Furthermore, multiple different light sources may be used to emit different color lights of the color spectrum. In an implementation, these multiple light sources may be leveraged to illuminate individual micro-holes in a different color or light intensity than different micro-holes of the micro-hole structure. This may further enable customization of a micro-hole structure logo to display colors or light intensities generally associated with a corporate logo. Although illustrated as configured in the shape of a logo, it should be understood that the micro-holes of the micro-hole structure 706 may be arranged and illuminated in any manner. For example, micro-holes may be arranged as alphabetic letters to enable personalization of a device supporting micro-hole structures.

The micro-holes of the micro-hole structure 706 may be formed according to the procedure described above with respect to FIG. 4. Additionally, the micro-holes for the micro-hole structure may be formed in any suitable way including, but not limited to, laser etching, drilling, mechanical punching, chemical etching, molding, and so forth. Optionally, a laser may be used as a finishing step to provide “blackmarking” of the micro-holes, which further effectively obscures the existence of the micro-holes or emphasizes a logo or design formed by the micro-hole structure.

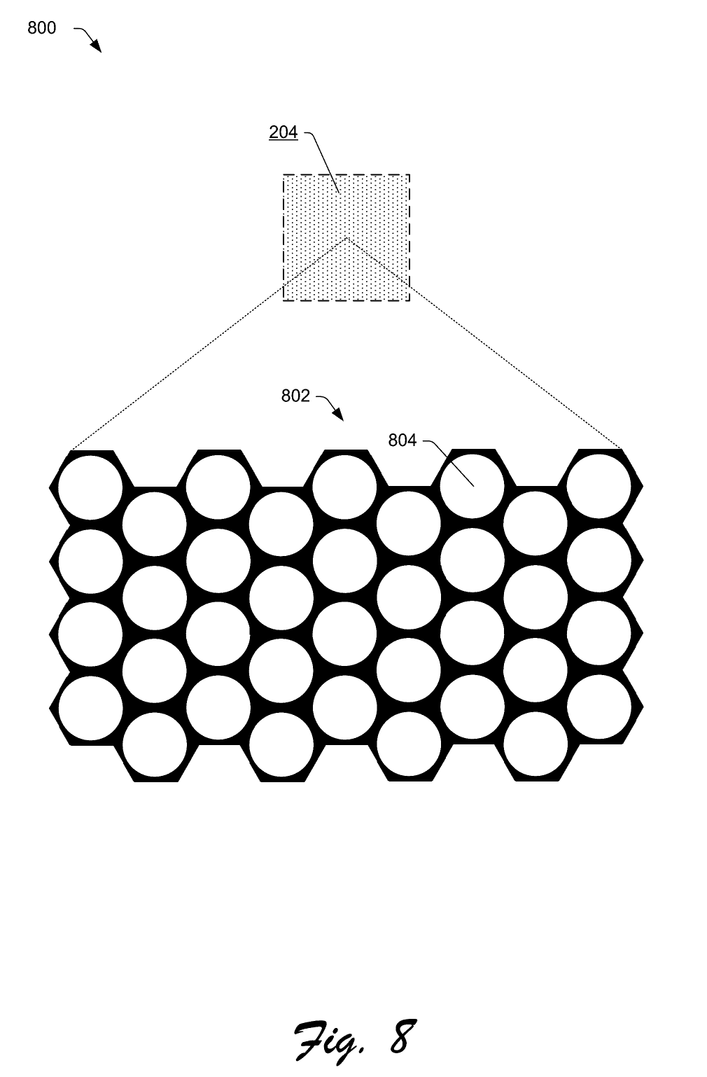

FIG. 8 depicts generally at 800 an example pattern of micro-holes of a micro-hole structure in accordance with one or more implementations. Here, a close-up view 802 of a portion of a micro-hole structure 204 is illustrated to show but one example arrangement of micro-holes 804 in a pattern. As discussed above, the arrangement of micro-holes is defined by the base die 302's plurality of pins 306 used to construct the micro-hole structure. In particular, FIG. 8 depicts a honey-comb or hexagonal pattern that may be employed in one or more implementations. A variety of other suitable patterns or arrangements may also be employed. In general, a suitable pattern enables close packing of the micro-holes 804 to provide enough coverage for sufficient fluid flow through the micro-hole structure. As illustrated, this close packing of the micro-holes in a micro-hole structure creates a structure with “open areas”, formed by the micro-holes, covering greater than fifty percent of an entire area of the micro-hole structure.

Example System and Device

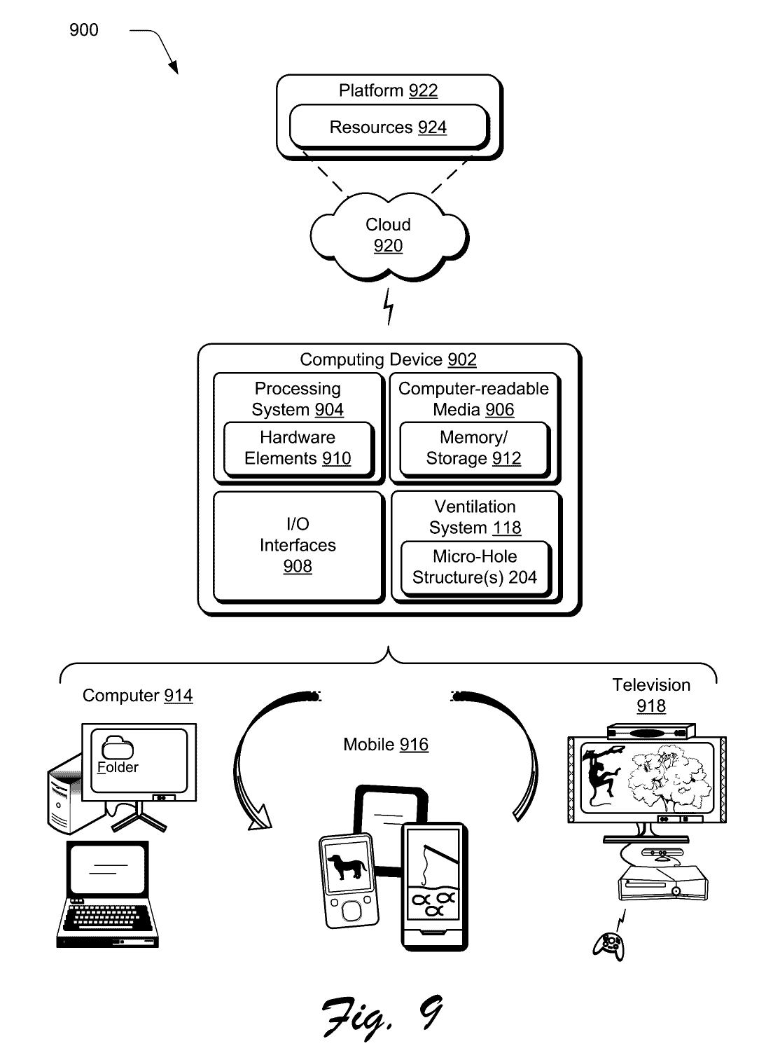

FIG. 9 illustrates an example system generally at 900 that includes an example computing device 902 that is representative of one or more computing systems and/or devices that may implement the various techniques described herein. The computing device 902 may be, for example, a server of a service provider, a device associated with a client (e.g., a client device), an on-chip system, and/or any other suitable computing device or computing system.

The example computing device 902 as illustrated includes a processing system 904, one or more computer-readable media 906, and one or more I/O interface 908 that are communicatively coupled, one to another. The computing device may also include a ventilation system 118 having micro-hole structures 204 as described herein. Although not shown, the computing device 902 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 904 is representative of functionality to perform one or more operations using hardware. Accordingly, the processing system 904 is illustrated as including hardware element 910 that may be configured as processors, functional blocks, and so forth. This may include implementation in hardware as an application specific integrated circuit or other logic device formed using one or more semiconductors. The hardware elements 910 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 906 is illustrated as including memory/storage 912. The memory/storage 912 represents memory/storage capacity associated with one or more computer-readable media. The memory/storage component 912 may include volatile media (such as random access memory (RAM)) and/or nonvolatile media (such as read only memory (ROM), Flash memory, optical disks, magnetic disks, and so forth). The memory/storage component 912 may include fixed media (e.g., RAM, ROM, a fixed hard drive, and so on) as well as removable media (e.g., Flash memory, a removable hard drive, an optical disc, and so forth). The computer-readable media 906 may be configured in a variety of other ways as further described below.

Input/output interface(s) 908 are representative of functionality to allow a user to enter commands and information to computing device 902, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 902 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 902. By way of example, and not limitation, computer-readable media may include “computer-readable storage media” and “computer-readable signal media.”

“Computer-readable storage media” refers to media and/or devices that enable storage of information in contrast to mere signal transmission, carrier waves, or signals per se. Thus, computer-readable storage media does not include signal-bearing medium, transitory signals, or signals per se. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” refers to a signal-bearing medium that is configured to transmit instructions to the hardware of the computing device 902, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 910 and computer-readable media 906 are representative of modules, programmable device logic and/or fixed device logic implemented in a hardware form that may be employed in some implementations to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 910. The computing device 902 may be configured to implement particular instructions and/or functions corresponding to the software and/or hardware modules. Accordingly, implementation of a module that is executable by the computing device 902 as software may be achieved at least partially in hardware, e.g., through use of computer-readable storage media and/or hardware elements 910 of the processing system 904. The instructions and/or functions may be executable/operable by one or more articles of manufacture (for example, one or more computing devices 902 and/or processing systems 904) to implement techniques, modules, and examples described herein.

As further illustrated in FIG. 9, the example system 900 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 900, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link.

In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 902 may assume a variety of different configurations, such as for computer 914, mobile 916, and television 918 uses. Each of these configurations includes devices that may have generally different constructs and capabilities, and thus the computing device 902 may be configured according to one or more of the different device classes. For instance, the computing device 902 may be implemented as the computer 914 class of a device that includes a personal computer, desktop computer, a multi-screen computer, laptop computer, netbook, and so on. Computing device 902 may be a wearable device, such as a watch or a pair of eye glasses, or may be included in a household, commercial, or industrial appliance.

The computing device 902 may also be implemented as the mobile 916 class of device that includes mobile devices, such as a mobile phone, portable music player, portable gaming device, a tablet computer, a multi-screen computer, and so on. The computing device 902 may also be implemented as the television 918 class of device that includes devices having or connected to generally larger screens in casual viewing environments. These devices include televisions, set-top boxes, gaming consoles, and so on.

The techniques described herein may be supported by these various configurations of the computing device 902 and are not limited to the specific examples of the techniques described herein.

Functionality may also be implemented all or in part through use of a distributed system, such as over a “cloud” 920 via a platform 922 as described below. The cloud 920 includes and/or is representative of a platform 922 for resources 924. The platform 922 abstracts underlying functionality of hardware (e.g., servers) and software resources of the cloud 920. The resources 924 may include applications and/or data that can be utilized while computer processing is executed on servers that are remote from the computing device 902. Resources 924 can also include services provided over the Internet and/or through a subscriber network, such as a cellular or Wi-Fi network.

The platform 922 may abstract resources and functions to connect the computing device 902 with other computing devices. The platform 922 may also serve to abstract scaling of resources to provide a corresponding level of scale to encountered demand for the resources 924 that are implemented via the platform 922. Accordingly, in an interconnected device embodiment, implementation of functionality described herein may be distributed throughout the system 900. For example, the functionality may be implemented in part on the computing device 902 as well as via the platform 922 that abstracts the functionality of the cloud 920.

### Conclusion and Example Implementations

Example implementations described herein include, but are not limited to, one or any combinations of one or more of the following examples:

In one or more examples, a method for constructing a micro-hole structure includes stretching a material onto a base die that includes one or more pins extending away from the base die so that the one or more pins of the base die protrude through the material; saturating the material with an adhesive; compressing the material saturated with the adhesive between the base die and a tip die that includes one or more receiving holes that are configured to receive the one or more pins of the base die; curing the material saturated with the adhesive to form a micro-hole structure having one or more micro-holes; cooling the base die and the top die to an ejection temperature and removing the micro-hole structure.

An example as described alone or in combination with any of the other examples described above or below, wherein individual ones of the one or more micro-holes of the micro-hole structure have a diameter of between about fifty microns and two-hundred microns.

An example as described alone or in combination with any of the other examples described above or below, wherein the material is carbon fiber.

An example as described alone or in combination with any of the other examples described above or below, wherein the adhesive is a heat-curable epoxy and wherein curing the material saturated with the adhesive includes heating both the base die and the top die to a temperature that is sufficient to cure material saturated with the heat-curable epoxy.

An example as described alone or in combination with any of the other examples described above or below, wherein the one or more micro-holes of the micro-hole structure are arranged in the shape of a logo.

An example as described alone or in combination with any of the other examples described above or below, wherein the one or more micro-holes of the micro-hole structure are of a sufficient size to permit air flow and restrict permeation of one or more of dust or water.

An example as described alone or in combination with any of the other examples described above or below, wherein the micro-hole structure having one or more micro-holes is a handheld form factor for a computing device.

An example as described alone or in combination with any of the other examples described above or below, wherein a profile of individual ones of the one or more micro-holes of the micro structure is one of: a conical shaped tube; an elliptical pipe; a hexagonal shape structure; or a rectangular passage.

An example as described alone or in combination with any of the other examples described above or below, wherein the one or more micro-holes of the micro-hole structure cover more than fifty percent of a surface area of the micro-hole structure.

In one or more examples, a computing device includes a ventilation system for thermal cooling of the computing device including a blower; a housing in which components of the computing device are mounted; and one or more micro-hole structures, the one or more micro-hole structures being a material saturated with an adhesive and cured, individual ones of the one or more micro-hole structures including a plurality of micro-holes that enable air to flow through the micro-hole structure and prevent contaminants from passing through the micro-hole structure.

An example as described alone or in combination with any of the other examples described above or below, wherein individual ones of the one or more micro-hole structures are less than two-hundred and fifty microns wide.

An example as described alone or in combination with any of the other examples described above or below, wherein the housing includes the one or more micro-hole structures.

An example as described alone or in combination with any of the other examples described above or below, wherein the one or more micro-hole structures are attached to the housing.

An example as described alone or in combination with any of the other examples described above or below, the computing device further including one or more light sources, the one or more light sources disposed within the housing and configured to emit light to pass through one or more of the plurality of micro-holes of the one or more micro-hole structures, and wherein the plurality of micro-holes of the one or more micro-hole structures are arranged in the shape of a logo to be illuminated by the one or more light sources.

An example as described alone or in combination with any of the other examples described above or below, wherein the material is carbon-fiber and the adhesive saturating the carbon-fiber is a heat-curable epoxy.

An example as described alone or in combination with any of the other examples described above or below, the computing device further including one or more heat-generating devices disposed within the housing, wherein the one or more micro-hole structures are positioned at one or more locations on the housing corresponding to one or more locations of the one or more heat-generating devices disposed within the housing.

An example as described alone or in combination with any of the other examples described above or below, wherein the computing device is configured as a mobile computing device having a handheld form factor.

In one or more examples, a housing for a computing device includes a plurality of micro-holes configured to enable air to flow through the housing and prevent contaminants from passing through the housing, the housing including the plurality of micro-holes being cured carbon fiber saturated with epoxy, each of the plurality of micro-holes being less than two-hundred and fifty microns wide.

An example as described alone or in combination with any of the other examples described above or below, wherein the plurality of micro-holes are arranged in a shape of a logo.

An example as described alone or in combination with any of the other examples described above or below, wherein the plurality of micro-holes cover more than fifty percent of a surface area of the housing.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method for constructing a micro-hole structure, the method comprising:
stretching a material onto a base die that includes one or more pins extending away from the base die so that the one or more pins of the base die protrude through the material;
saturating the material with an adhesive;
positioning a top die proximal to the base die, the top die including one or more receiving holes that are configured to receive the one or more pins of the base die;
compressing the material saturated with the adhesive between the base die and the top die;
curing the material saturated with the adhesive to form a micro-hole structure having one or more micro-holes;
cooling the base die and the top die to an ejection temperature and removing the micro-hole structure.

2. A method as described in claim 1, wherein individual ones of the one or more micro-holes of the micro-hole structure have a diameter of between about fifty microns and two-hundred microns.

3. A method as described in claim 1, wherein the material is carbon fiber.

4. A method as described in claim 1, wherein the adhesive is a heat-curable epoxy and wherein curing the material saturated with the adhesive comprises heating both the base die and the top die to a temperature that is sufficient to cure material saturated with the heat-curable epoxy.

5. A method as described in claim 1, wherein the one or more micro-holes of the micro-hole structure are arranged in a shape of a logo.

6. A method as described in claim 1, wherein the one or more micro-holes of the micro-hole structure are of a sufficient size to permit air flow and restrict permeation of one or more of dust or water.

7. A method as described in claim 1, wherein the micro-hole structure having one or more micro-holes is a handheld form factor for a computing device.

8. A method as described in claim 1, wherein a profile of individual ones of the one or more micro-holes of the micro-hole structure is one of:
a conical shaped tube;
an elliptical pipe;
a hexagonal shape structure; or
a rectangular passage.

9. A method as described in claim 1, wherein the one or more micro-holes of the micro-hole structure cover more than fifty percent of a surface area of the micro-hole structure.

10. A computing device comprising:
a ventilation system for thermal cooling of the computing device including a blower;
a housing in which components of the computing device are mounted; and
one or more micro-hole structures, the one or more micro-hole structures being a material saturated with an adhesive and cured, individual ones of the one or more micro-hole structures including a plurality of micro-holes that enable air to flow through the micro-hole structure and prevent contaminants from passing through the micro-hole structure.

11. A computing device as described in claim 10, wherein individual ones of the plurality of micro-holes of the one or more micro-hole structures are less than two-hundred and fifty microns wide.

12. A computing device as described in claim 10, wherein the housing includes the one or more micro-hole structures.

13. A computing device as described in claim 10, wherein the one or more micro-hole structures are attached to the housing.

14. A computing device as described in claim 10, the computing device further comprising one or more light sources, the one or more light sources disposed within the housing and configured to emit light to pass through one or more of the plurality of micro-holes of the one or more micro-hole structures, and wherein the plurality of micro-holes of the one or more micro-hole structures are arranged in the shape of a logo to be illuminated by the one or more light sources.

15. A computing device as described in claim 10, wherein the material is carbon-fiber and the adhesive saturating the carbon-fiber is a heat-curable epoxy.

16. A computing device as described in claim 10, the computing device further comprising one or more heat-generating devices disposed within the housing, wherein the one or more micro-hole structures are positioned at one or more locations on the housing corresponding to one or more locations of the one or more heat-generating devices disposed within the housing.

17. A computing device as described in claim 10, wherein the computing device is configured as a mobile computing device having a handheld form factor.

18. A housing for a computing device, the housing for the computing device including a plurality of micro-holes configured to enable air to flow through the housing and prevent contaminants from passing through the housing, the housing including the plurality of micro-holes being cured carbon fiber saturated with epoxy, each of the plurality of micro-holes being less than two-hundred and fifty microns wide.

19. A housing as described in claim 18, wherein the plurality of micro-holes are arranged in a shape of a logo.

20. A housing as described in claim 18, wherein the plurality of micro-holes cover more than fifty percent of a surface area of the housing.
